(19) United States
(12) Patent Application Publication
(10) Pub. No.: US 2016/0346948 A1
(43) Pub. Date: Dec. 1, 2016

(54) CLAMPING SYSTEM AND SUBSTRATE-CUTTING APPARATUS EMPLOYING THE SAME

(71) Applicant: Samsung Display Co., Ltd., Yongin-Si (KR)

(72) Inventor: Kwonil Lee, Giheung-gu (KR)

(21) Appl. No.: 14/957,712

(22) Filed: Dec. 3, 2015

(30) Foreign Application Priority Data
Jun. 1, 2015 (KR) 10-2015-0077479

(51) Int. Cl. B26D 7/01; G02F 1/13; G02F 1/1333; B26D 3/08

(52) U.S. Cl. CPC B26D 7/018; B26D 3/085; G02F 1/1303; G02F 1/133351

(57) ABSTRACT

A clamping system includes a clamp unit lengthwise extended across a working line direction along which a cutting process of a mother substrate is performed; a clamp unit on the clamp unit body, the clamp unit including a vacuum clamp to which the mother substrate is fixable via vacuum absorption; and a vacuum system which provides the vacuum absorption via which the mother substrate is fixed to the vacuum clamp.

This application claims priority to Korean Patent Application No. 10-2015-0077479, filed on Jun. 1, 2015, and all the benefits accruing therefrom under 35 U.S.C. §119, the disclosure of which is incorporated herein in its entirety by reference.

### BACKGROUND

1. Field

One or more exemplary embodiments relate to a clamping system and a substrate-cutting apparatus employing the same.

2. Description of the Related Art

Flat panel displays include various types, such as a liquid crystal display (“LCD”), an organic light-emitting device (“OLED”) display, etc.

For example, an LCD has a structure in which a liquid crystal layer is formed by injecting a liquid crystal between an upper plate and a lower plate, the upper plate and the lower plate including a glass material and being bonded to each other, to manufacture an LCD panel of the LCD. A color filter, for example, is provided in the upper plate, and a thin film transistor (“TFT”), for example, is provided in the lower plate.

Commercialized LCD panels have various sizes, and have a structure in which an upper plate and a lower plate thereof are bonded to each other. An LCD panel is manufactured by forming unit substrates by cutting a mother substrate, which has a relatively large area, into, for example, a few or dozens of divisions, via a cutting process, and mounting driving circuits, etc. on pad portions of the unit substrates via a module process.

Here, the cutting process for cutting the mother substrate into the unit substrates is performed by a substrate-cutting apparatus, which is also referred to as a scribe apparatus.

In order to cut the mother substrate into the unit substrates along a scribe line, which is a reference line for cutting, a position of the mother substrate is fixed such as by using a clamping system.

### SUMMARY

One or more exemplary embodiments include a clamping system which reduces defect occurrences during a scribing process for a substrate, and a substrate-cutting apparatus employing the same.

According to one or more exemplary embodiments, a clamping system includes a clamp unit body lengthwise extended across a working line direction along which a cutting process of a mother substrate is performed; a clamp unit on the clamp unit body, the clamp unit including a vacuum clamp to which the mother substrate is fixable via vacuum absorption; and a vacuum system which provides the vacuum absorption via which the mother substrate is fixed to the vacuum clamp.

The vacuum clamp may include a clamping chuck in which a vacuum hole is defined in a first surface thereof which contacts the mother substrate when the mother substrate is fixed to the vacuum clamp, and in a state of the clamping chuck near the mother substrate, the vacuum absorption provided by the vacuum system fixes the mother substrate to the clamping chuck.

The clamping chuck may be rotatable within the vacuum clamp.

The mother substrate which is fixable to the clamp unit via vacuum absorption may include an upper plate and a lower plate.

The mother substrate which is fixable to the clamp unit via vacuum absorption may include a liquid crystal display panel including the upper plate and the lower plate bonded to each other, each of the upper and lower plates including a transparent substrate.

According to one or more exemplary embodiments, a substrate-cutting apparatus includes a scribe unit by which a scribe line is formed on a mother substrate; and a clamping system by which a position of the mother substrate is fixable with respect to the scribe unit, the clamping system restricting movement of the mother substrate when the scribe line is formed is formed on the mother substrate The clamping system includes: a clamp unit body lengthwise extended across a working line direction along which a cutting process of the mother substrate is performed via the scribe unit with reference to the scribe line formed on the mother substrate; a clamp unit on the clamp unit body, the clamp unit including a vacuum clamp to which the mother substrate is fixable via vacuum absorption; and a vacuum system which provides the vacuum absorption via which the mother substrate is fixed to the vacuum clamp.

The vacuum clamp may include a clamping chuck in which a vacuum hole is defined in a first surface thereof which contacts the mother substrate when the mother substrate is fixed to the vacuum clamp, and in a state of the clamping chuck near the mother substrate, the vacuum absorption provided by the vacuum system fixes the mother substrate to the clamping chuck.

The clamping chuck may be rotatable within the vacuum clamp.

The mother substrate which is fixable to the clamp unit via vacuum absorption may include an upper plate and a lower plate.

The mother substrate which is fixable to the clamp unit via vacuum absorption may include a liquid crystal display panel including the upper plate and the lower plate bonded to each other, each of the upper and lower plates including a transparent substrate.

The apparatus may further include a substrate transportation unit by which the mother substrate is transported to a location at which the scribe unit forms the scribe line.

The clamp unit body on which the clamp unit is disposed may be disposed above the substrate transportation unit and lengthwise extended across the working line direction.

### BRIEF DESCRIPTION OF THE DRAWINGS

These and/or other features will become apparent and more readily appreciated from the following description of the exemplary embodiments, taken in conjunction with the accompanying drawings in which:

FIG. 1 is a perspective view of an exemplary embodiment of a clamp unit of a clamping system according to the invention;

FIG. 2 is a perspective view of a main portion of an exemplary embodiment of a substrate-cutting apparatus in which a clamping system thereof employs the clamp unit of FIG. 1;

FIG. 3 illustrates a side view of an exemplary embodiment of a scribe unit in the substrate-cutting apparatus of FIG. 2 relative to a clamp unit and a mother substrate which has an upper plate and a lower plate bonded to each other; and

FIGS. 4 and 5 are views for describing an exemplary embodiment of a process of performing a scribe process on a mother substrate by using the scribe unit of FIG. 3.

### DETAILED DESCRIPTION

Reference will now be made in detail to exemplary embodiments, examples of which are illustrated in the accompanying drawings, where like reference numerals refer to like elements throughout. In this regard, the exemplary embodiments may have different forms and should not be construed as being limited to the descriptions set forth herein. Accordingly, the exemplary embodiments are merely described below, by referring to the figures, to explain features of the description.

Expressions such as “at least one of,” when preceding a list of elements, modify the entire list of elements and do not modify the individual elements of the list.

It will be understood that although the terms “first,” “second,” etc. may be used herein to describe various components, these components should not be limited by these terms. These components are only used to distinguish one component from another.

As used herein, the singular forms “a,” “an,” and “the” are intended to include the plural forms as well, unless the context clearly indicates otherwise. “Or” means “and/or.” As used herein, the term “and/or” includes any and all combinations of one or more of the associated listed items.

It will be further understood that the terms “comprises” and/or “comprising” used herein specify the presence of stated features or components, but do not preclude the presence or addition of one or more other features or components.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

It will be understood that when a layer, region, or component is referred to as being “formed on,” another layer, region, or component, it can be directly or indirectly formed on the other layer, region, or component. That is, for example, intervening layers, regions, or components may be present.

Sizes of elements in the drawings may be exaggerated for convenience of explanation. In other words, since sizes and thicknesses of components in the drawings are arbitrarily illustrated for convenience of explanation, the following embodiments are not limited thereto.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

When a certain embodiment may be implemented differently, a specific process order may be performed differently from the described order. For example, two consecutively described processes may be performed substantially at the same time or performed in an order opposite to the described order.

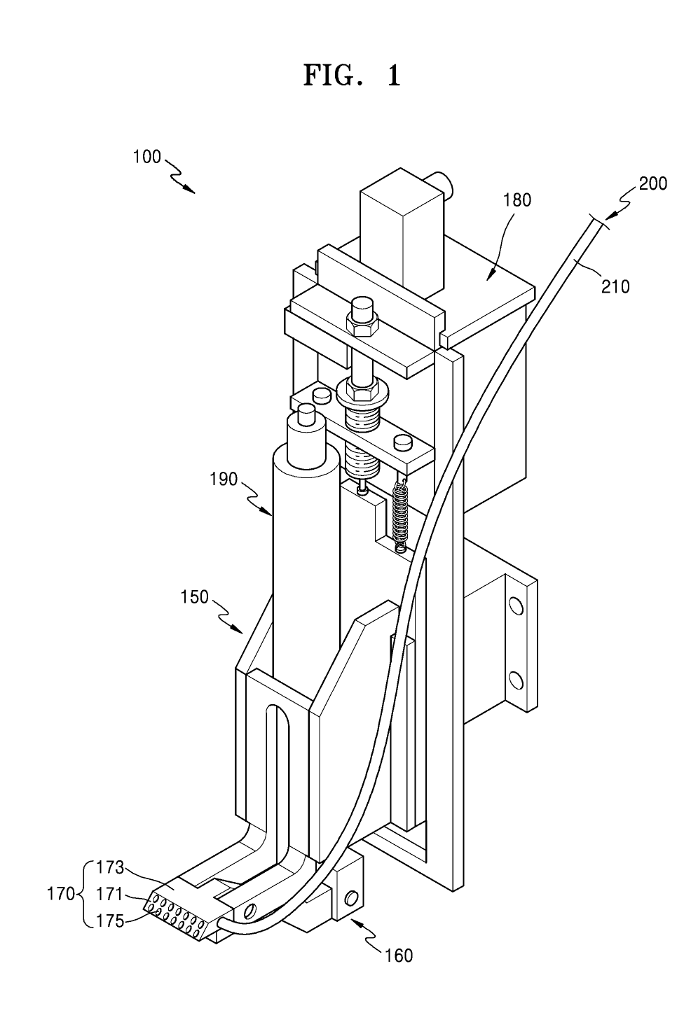

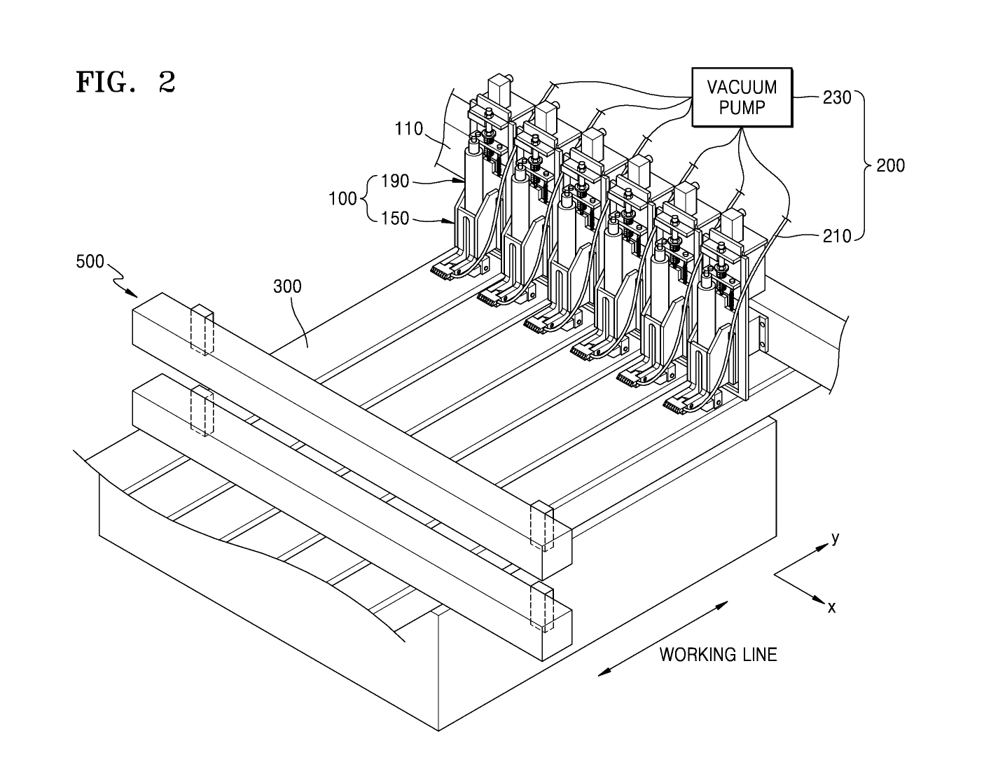

FIG. 1 is a perspective view of an exemplary embodiment of a clamp unit 150 of a clamping system 100 according to the invention. FIG. 2 is a perspective view of a main portion of an exemplary embodiment of a substrate-cutting apparatus in which the clamping system 100 thereof employs the clamp unit 150 of FIG. 1.

Referring to FIGS. 1 and 2, the clamping system 100 fixes a mother substrate that is to be cut into a plurality of unit substrates. In an exemplary embodiment, for example, with a mother substrate is on a substrate transportation unit 300, when a scribe line is formed on the mother substrate by a scribe unit 500, the clamping system 100 clamps the mother substrate so that an accurate scribe line may be formed. The clamping of the mother substrate may fix a position of the mother substrate relative to other components of the substrate-cutting apparatus.

The clamping system 100 includes a clamp unit body 110 on which the clamp unit 150 is provided, and a vacuum system 200.

The clamp unit body 110 is disposed extended across a working line (direction) along which a cutting process of the mother substrate is performed. The working line may lengthwise extend along a y-axis. The clamp unit 150 which is configured to clamp the mother substrate may be provided in plural. Each of the plurality of clamp units 150 may be detachably coupled to the clamp unit body 110. The clamp unit body 110 may be arranged lengthwise across the working line. That is, the clamp unit body 110 may be lengthwise extended a direction of an x-axis, and may be connected to a clamp unit movement unit (not shown).

The clamp unit 150 may be coupled to the clamp unit body 110 in plural such that the clamp units 150 are spaced apart from one another in the length direction of the clamp unit body 110. The clamp unit 150 may include a vacuum clamp 160 configured to clamp the mother substrate via vacuum absorption, and an elevating driving unit 180 configured to raise and lower the vacuum clamp 160. The clamp unit 150 clamps the mother substrate only at a lower surface thereof. That is, the clamp unit 150 does not contact and is not clamped to one of an upper surface and a lower surface of the mother substrate and completely exposes the other one of the upper surface and the lower surface of the mother substrate. The vacuum absorption includes applying a negative force to the mother substrate to draw and hold the mother substrate to the vacuum clamp 160.

The vacuum clamp 160 includes a clamping chuck 170 in which a vacuum hole 175 is defined at a first surface 171 of the vacuum clamp 160 which contacts the mother substrate. The vacuum hole 175 at the first surface 171 may be fluidly connected to a passage within a body of the clamping chuck 170. The vacuum hole 175 may be provided in plural at the first surface 171 and connected to the vacuum system 200 via a plurality of passages in the clamping chuck 170. With the clamping chuck 170 placed near the mother substrate, the mother substrate is vacuum-absorbed and fixed against the clamping chuck 170 by an operation of the vacuum system 200 connected thereto.

The clamping chuck 170 may be provided as a rotatable chuck within the vacuum clamp 160. When the clamping chuck 170 is the rotatable chuck, the clamp unit 150 may further include a rotatable chuck driving unit 190 configured to rotate the clamping chuck 170. When the clamping chuck 170 is rotated by the rotatable chuck driving unit 190 so that the first surface 171 in which the vacuum holes 175 are defined contacts the mother substrate, and the vacuum system 200 is operated, the mother substrate is vacuum-absorbed and fixed against the clamping chuck 170. The first surface 171 in which the vacuum holes 175 are defined may be a surface which may face the mother substrate by the rotation of the clamping chuck 170.

FIG. 1 illustrates an example in which the clamping chuck 170 is formed to be rotatable. However, in an alternative exemplary embodiment, the clamping chuck 170 may be a fixed chuck. When the clamping chuck 170 is a fixed chuck, the rotatable chuck driving unit 190 may be omitted, and the vacuum holes 175 may be provided at a second surface 173 of the clamping chuck 170, so as to face the mother substrate. Hereinafter, the example in which the clamping chuck 170 is formed to be rotatable will be further described.

The vacuum system 200 may include a pipe 210 fluidly connected to the vacuum holes 175 via the passages defined in the clamping chuck 170, and a vacuum pump 230 which draws out air via the pipe 210 so that the first surface 171 of the clamping chuck 170 in which the vacuum holes 150 are defined and the mother substrate are vacuum-absorbed to each other. FIGS. 1 and 2 illustrate an example in which the pipe 210 is fluidly connected to the vacuum holes 175 via a side surface of the clamping chuck 170. The connection between the pipe 210 and the vacuum holes 175 may be defined in another portion of the clamping chuck 170 and/or the vacuum clamp 160. Also, components of the vacuum system 200 may vary.

Referring to FIG. 2, the substrate-cutting apparatus may include the scribe unit 500 configured to form a scribe line on the mother substrate, and the clamping system 100 configured to fix a position of the mother substrate so that the mother substrate does not move during forming of the scribe line thereon. Also, the substrate-cutting apparatus may further include the substrate transportation unit 300 configured to transport the mother substrate between locations such as transporting the mother substrate to a location at which the scribe line is formed thereon and transporting the mother substrate having the scribe line formed thereon to a location at which a sequential process is performed.

The substrate transportation unit 300 configured to transport the mother substrate which is subjected to a cutting process, transports the mother substrate in a direction that is parallel to the working line, that is, a direction of the y-axis. The substrate transportation unit 300 may include a belt conveyor type substrate transportation unit, a roller type substrate transportation unit, a state type substrate transportation unit, etc. FIG. 2 illustrates an example in which the substrate transportation unit 300 employs a belt conveyor type. The substrate transportation unit 300 may have a structure in which a plurality of belt conveyors is arranged on a flat surface to define one or more spaces among the belt conveyors.

As illustrated in FIG. 2, when the substrate-cutting apparatus further includes the substrate transportation unit 300, the clamp unit body 110 may be lengthwise disposed above the substrate transportation unit 300 to extend across the working line along which the cutting process of the mother substrate is performed.

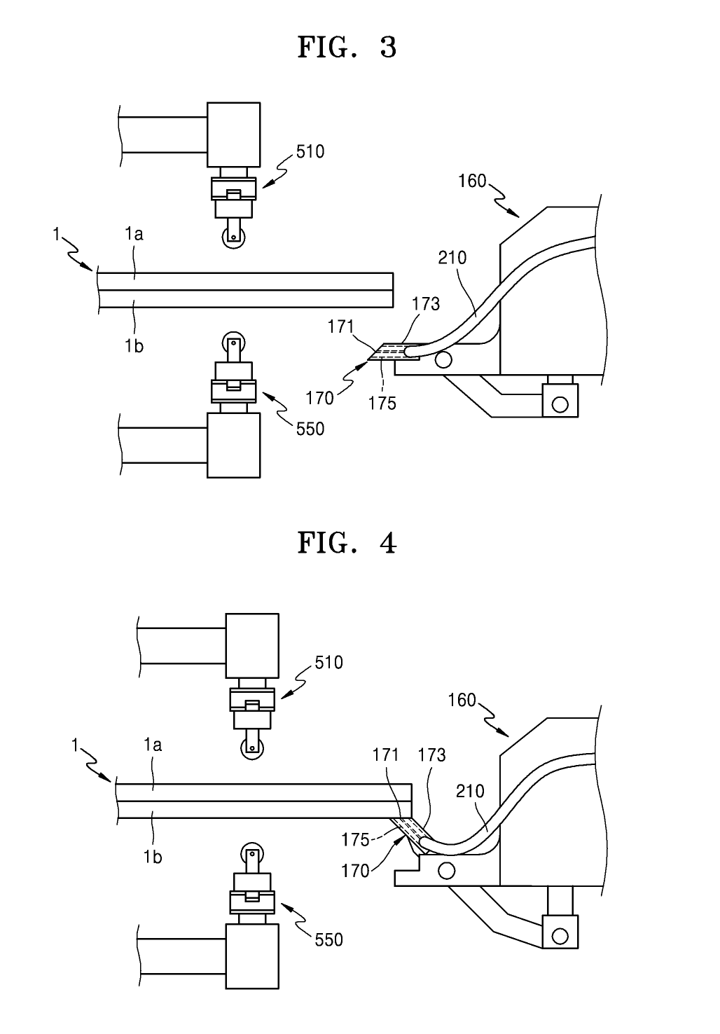

FIG. 3 illustrates a side view of an exemplary embodiment of a scribe unit in the substrate-cutting apparatus of FIG. 2 relative to a clamp unit and a mother substrate which has an upper plate and a lower plate bonded to each other.

The scribe unit 500 forms the scribe line on the mother substrate. The formed scribe line is a reference line along which the mother substrate is cut. The scribe unit 500 may include an upper scribe unit 510 configured to form a scribe line on an upper plate 1a defining an upper surface of a mother substrate 1, and a lower scribe unit 550 configured to form a scribe line on a lower plate 1b defining a lower surface of the mother substrate 1.

The mother substrate 1 may be a collective substrate for which the upper plate 1a and the lower plate 1b are bonded to each other. That is, the collective substrate may include an array of liquid crystal display panels each of which includes two transparent substrates bonded to each other. In an exemplary embodiment, each of a plurality of unit substrates that are separated from the mother substrate 1 along the scribe lines formed by the upper scribe unit 510 and the lower scribe unit 550 may correspond to a liquid crystal display panel among the array of liquid crystal display panels.

FIG. 3 illustrates an example in which the scribe unit 500 includes the upper scribe unit 510 and the lower scribe unit 550 for forming a scribe line on the mother substrate 1 in which the upper plate 1a and the lower plate 1b are bonded to each other. Here, when the mother substrate 1 includes a single plate and forming a scribe line on an upper surface or a lower surface of the single plate of the mother substrate 1, the scribe unit 500 may include either the upper scribe unit 510 or the lower scribe unit 550.

Hereinafter, the example in which the scribe unit 500 includes both of the upper scribe unit 510 and the lower scribe unit 550 will be further described.

The upper scribe unit 510 and the lower scribe unit 550 are provided to face each other with the mother substrate 1 therebetween. The scribe line may be formed on each of the upper plate 1a and the lower plate 1b of the mother substrate 1 by the upper scribe unit 510 and the lower scribe unit 550, respectively.

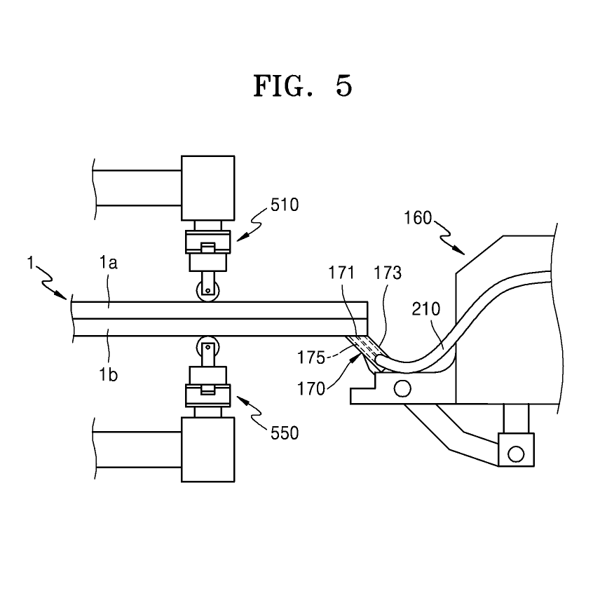

FIGS. 4 and 5 illustrate an exemplary embodiment of a process of performing a scribe process on the mother substrate 1 by using the scribe unit 500 of FIG. 3. FIG. 4 illustrates a state in which the mother substrate 1 is vacuum-absorbed and fixed against the clamping chuck 170. FIG. 5 illustrates a state in which the upper scribe unit 510 and the lower scribe unit 550 are in contact with the upper surface and the lower surface of the mother substrate 1 while the mother substrate 1 is vacuum-absorbed and fixed against the clamping chuck 170.

Referring to FIG. 1 and FIG. 3, the clamping chuck 170 is disposed in a non-rotated state such that the second surface 173 faces upward and the first surface 171 is directed along the working line.

Referring to FIG. 4, before the scribe line is formed on a surface of the mother substrate 1, the clamping chuck 170 is rotated to be located near the mother substrate 1 or to contact the mother substrate 1. In the rotated state of the clamping chuck 170, the first surface 171 is directed upward to face the mother substrate 1. With the first surface 171 of the clamping chuck 170 facing the mother substrate 1, the vacuum system 200 is operated so that the mother substrate 1 is vacuum-absorbed onto the clamping chuck 170. The mother substrate 1 is vacuum-absorbed onto the first surface 171 of the clamping chuck 170. The clamping chuck 170 clamps the mother substrate 1 only at a lower surface thereof. That is, the clamping chuck 170 does not contact and is not clamped to an upper surface of the mother substrate 1 and completely exposes the upper surface of the mother substrate 1.

The elevating driving unit 180 may adjust a height of the clamping unit 150 with respect to a plane in which the mother substrate 1 is disposed, and then, the rotational chuck driving unit 190 and the vacuum system 200 may be operated so that the mother substrate 1 is vacuum-absorbed on the clamping chuck 170 as described above.

While the mother substrate 1 is vacuum-absorbed and fixed against the clamping chuck 170 as described above, the upper scribe unit 510 and the lower scribe unit 550 are moved to contact an upper surface of the upper plate 1a and a lower surface of the lower plate 1b of the mother substrate 1, as illustrated in FIG. 5. In this state, the scribe line may be formed on each of the upper plate 1a and the lower plate 1b of the mother substrate 1, by using the upper scribe unit 510 and the lower scribe unit 550.

FIGS. 3 through 5 illustrate an example in which the upper scribe unit 510 and the lower scribe unit 550 of the scribe unit 500 include a wheel blade for forming the scribe line. However, the invention is not limited thereto, and may vary. In an exemplary embodiment, for example, the upper scribe unit 510 and the lower scribe unit 550 of the scribe unit 500 may be provided to form the scribe line by using a laser beam instead of a wheel blade.

By the process described above, one or more exemplary embodiment of the substrate-cutting apparatus according to the invention cuts the mother substrate 1 on which the scribe line is formed by the scribe unit 500 to separate the mother substrate 1 into a plurality of unit substrates with respect to the scribe line.

In another exemplary embodiment of a process of performing a scribe process on the mother substrate 1 by using the scribe unit 500, the clamping chuck 170 is a fixed chuck, the rotatable chuck driving unit 190 may be omitted, and the vacuum holes 175 may be provided at the second surface 173 of the clamping chuck 170 so as to face the mother substrate 1. When the clamping chuck 170 is a fixed chuck, the vacuum holes 175 may or may not be defined at the first substrate 171. Referring to FIG. 1 and FIG. 3 again, where the vacuum holes 175 are provided at the second surface 173 of the clamping chuck 170, the clamping chuck 170 is disposed in a non-rotated state such that the second surface 173 faces upward and the first surface 171 is directed along the working line.

Referring to FIG. 4 again, since the vacuum holes 175 are provided at the second surface 173 and since the second surface 173 faces upward in a non-rotated state of the clamping chuck 170, the vacuum system 200 may be operated so that the mother substrate 1 is vacuum-absorbed onto the clamping chuck 170. The mother substrate 1 is vacuum-absorbed onto the first surface 173 of the clamping chuck 170. With the mother substrate 1 vacuum-absorbed onto the first surface 173 of the clamping chuck 170, the scribe line may be formed by the scribe unit 500.

The substrate-cutting apparatus may further include a clamp unit transportation unit (not shown) configured to transport the clamp unit body 110 along the working line. Since the clamp unit 150 is coupled to the clamp unit body 110, when the clamp unit body 110 is transported along the working line by the clamp unit transportation unit, the clamp unit 150 coupled to the clamp unit body 110 is transported along the working line. Thus, the clamp unit transportation unit may transport the clamp unit 150 to fix a position of the mother substrate 1, along the work line direction, that is, the y axis direction. The clamp unit transportation unit may be embodied as, for example, a linear motor, etc. Here, the clamp unit transportation unit may be embodied by applying other driving systems than the linear motor.

As described above, according to one or more of the above exemplary embodiments, according to the clamping system and the substrate-cutting apparatus employing the clamping system, the mother substrate is fixed against the clamping chuck via vacuum absorption, and thus, defects in a scribe line due to a chuck unit level and a clamp gap difference may be obviated.

In a conventional clamping system and conventional substrate-cutting apparatus employing such clamping system including a fixed chuck or a rotational chuck, a clamp gap between upper and lower clamp members which apply a positive force to a mother substrate is adjusted by being set to be less than a total thickness of the mother substrate. With the clamp gap as less than a total thickness of a mother substrate, substrate cracks, that is, glass cracks or residues, may occur on a corresponding portion of the mother substrate at which the clamp applies the positive force to the mother substrate, thereby making the management of scribe equipment difficult. Also, in a conventional clamping system and conventional substrate-cutting apparatus employing such clamping system including the fixed chuck or the rotational chuck, plate separation within the mother substrate may occur due to a gap difference according to glass thicknesses, which leads to shifting during a cutting operation.

However, according to one or more exemplary embodiment of the clamping system and the substrate-cutting apparatus employing the same according to the invention, the mother substrate is fixed against the clamp chuck via vacuum absorption while excluding an upper clamp structure. Thus, by excluding the upper clamp structure, damage to the substrate due to a gap difference, shift cutting due to plate separation due to the gap difference, and residue on the plate due to a gap and a chuck level difference, may be obviated. Here, the plate may include or be formed of a glass.

It should be understood that exemplary embodiments described herein should be considered in a descriptive sense only and not for purposes of limitation. Descriptions of features within each exemplary embodiment should typically be considered as available for other similar features in other exemplary embodiments.

While one or more exemplary embodiments have been described with reference to the figures, it will be understood by those of ordinary skill in the art that various changes in form and details may be made therein without departing from the spirit and scope as defined by the following claims.

What is claimed is:

1. A clamping system comprising:
a clamp unit body lengthwise extended across a working line direction along which a cutting process of a mother substrate is performed;
a clamp unit on the clamp unit body, the clamp unit comprising a vacuum clamp to which the mother substrate is fixable via vacuum absorption; and
a vacuum system which provides the vacuum absorption via which the mother substrate is fixed to the vacuum clamp.

2. The clamping system of claim 1, wherein
the vacuum clamp comprises a clamping chuck in which a vacuum hole is defined in a first surface thereof which contacts the mother substrate when the mother substrate is fixed to the vacuum clamp, and
in a state of the clamping chuck near the mother substrate, the vacuum absorption provided by the vacuum system fixes the mother substrate to the clamping chuck.

3. The clamping system of claim 2, wherein the clamping chuck of the vacuum clamp is rotatable within the vacuum clamp.

4. The clamping system of claim 1, wherein the mother substrate which is fixable to the clamp unit via vacuum absorption comprises an upper plate and a lower plate.

5. The clamping system of claim 4, wherein the mother substrate which is fixable to the clamp unit via vacuum absorption comprises a liquid crystal display panel comprising the upper plate and the lower plate bonded to each other, each of the upper and lower plates comprising a transparent substrate.

6. A substrate-cutting apparatus comprising:
a scribe unit by which a scribe line is formed on a mother substrate; and
a clamping system by which a position of the mother substrate is fixable with respect to the scribe unit, the clamping system restricting movement of the mother substrate when the scribe line is formed is formed on the mother substrate,
wherein the clamping system comprises:
a clamp unit body lengthwise extended across a working line direction along which a cutting process of the mother substrate is performed via the scribe unit with reference to the scribe line formed on the mother substrate;
a clamp unit on the clamp unit body, the clamp unit comprising a vacuum clamp to which the mother substrate is fixable via vacuum absorption; and
a vacuum system which provides the vacuum absorption via which the mother substrate is fixed to the vacuum clamp.

7. The apparatus of claim 6, wherein
the vacuum clamp comprises a clamping chuck in which a vacuum hole is defined in a first surface thereof which contacts the mother substrate when the mother substrate is fixed to the vacuum clamp, and
in a state of the clamping chuck near the mother substrate, the vacuum absorption provided by the vacuum system fixes the mother substrate to the clamping chuck.

8. The apparatus of claim 7, wherein the clamping chuck of the vacuum clamp is rotatable within the vacuum clamp.

9. The apparatus of claim 6, further comprising a substrate transportation unit by which the mother substrate is transported to a location at which the scribe unit forms the scribe line.

10. The apparatus of claim 9, wherein the clamp unit body on which the clamp unit is disposed is disposed above the substrate transportation unit and lengthwise extended across the working line direction.

11. The apparatus of claim 6, wherein the mother substrate which is fixable to the clamp unit via vacuum absorption comprises an upper plate and a lower plate.

12. The apparatus of claim 11, wherein the mother substrate which is fixable to the clamp unit via vacuum absorption comprises a liquid crystal display panel comprising the upper plate and the lower plate bonded to each other, each of the upper and lower plates comprising a transparent substrate.

13. The apparatus of claim 11, further comprising a substrate transportation unit by which the mother substrate is transported to a location at which the scribe unit forms the scribe line.

14. The apparatus of claim 13, wherein the clamp unit body on which the clamp unit is disposed is disposed above the substrate transportation unit and lengthwise extended across the working line direction.

15. The clamping system of claim 2, wherein
in the state of the clamping chuck near the mother substrate, the vacuum absorption provided by the vacuum system fixes only a lower surface of the mother substrate to the first surface of the clamping chuck.

16. The apparatus of claim 7, wherein
in the state of the clamping chuck near the mother substrate, the vacuum absorption provided by the vacuum system fixes only a lower surface of the mother substrate to the first surface of the clamping chuck.
